(19) United States
(12) Patent Application Publication
(10) Pub. No.: US 2011/0114030 A1
(43) Pub. Date: May 19, 2011

(54) Pet Turtle Slope

(75) Inventor: David Kalei Kane Moopuna Perreira, Honolulu, HI (US)

(73) Assignee: Miriam Luana Perreira, Honolulu, HI (US)

(21) Appl. No.: 12/618,851

(22) Filed: Nov. 16, 2009

(51) Int. Cl. A01K 1/00

(52) U.S. Cl. 119/247

(57) ABSTRACT

A device for use in conjunction with a standard aquarium tank or similar container, to provide a habitat for water pets such as Red Eared Sliders or other land or water creatures. The device is sloped, utilizing a wedge-like shape, which rests at the bottom of the tank or container. The design is in such a way that the device does not move or float.

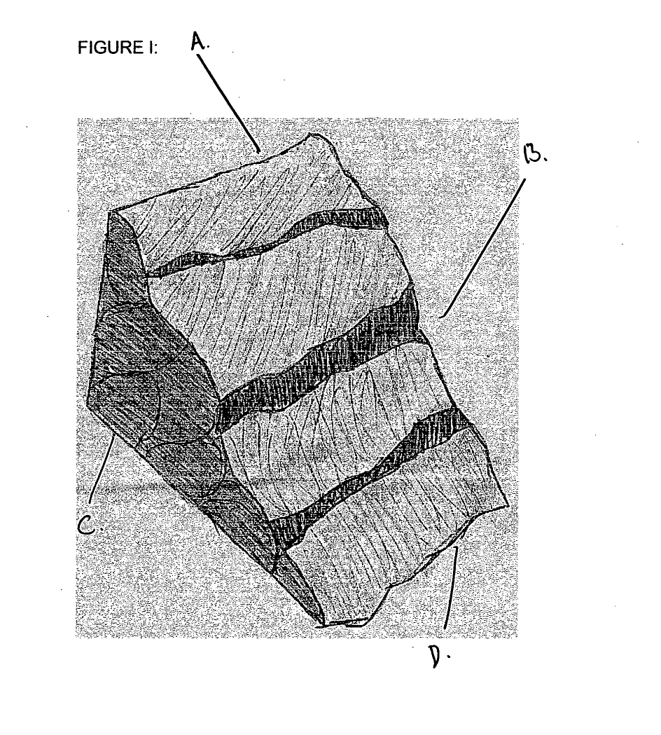

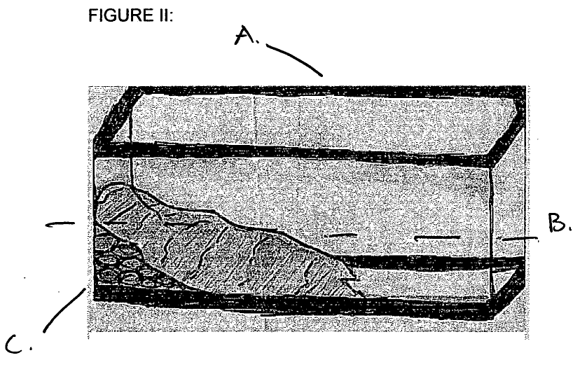

### CROSS-REFERENCE TO RELATED APPLICATIONS

Not Applicable

### FEDERALLY SPONSORED RESEARCH

Not Applicable

### SEQUENCE LISTING

Not Applicable

### BACKGROUND

The unit is designed for use with various water or land pets, but works specifically well with Red-Eared Slider water turtles. While I was a State of Hawaii Dept. of Agriculture employee, one of my routine tasks was to take care of various reptiles and amphibians within our animal amnesty center, and to keep their habitats clean. It was designed by myself because I see nothing like it in the current marketplace or in patent databases, and I strongly feel my design is superior in many ways to what is currently available, and I was tired of using products that are difficult to clean (especially when my job entailed cleaning turtle habitats at least thrice a week), as well as being problematic. The item gives turtles or other animals both a dry area, and a wet area, when used with an aquarium tank or other container.

To my knowledge, there are above water products, such as floating plastic “islands” or “logs,” and below water products, such as non-floating “logs.” There are multiple drawbacks which my unit overcomes.

(I could not find patents for these products, and the only specific documents I have found are those from online retailers. I own these two types of products, and have found these drawbacks myself as a pet owner.)

With free floating products, it is often difficult for turtles or other animals to climb onto these products, as they often move away from the creature while they try to climb on. Also, these products regularly bang against the walls of their holding containers, and may damage them, as well as annoy anyone around. With fixed, but floating products, such as plastic islands or logs which attach with suction cups, it is also difficult for turtles or other animals to climb on (especially younger ones.) Sometimes animals chew on the suction cups, making it dangerous for them, and usually even without animal interaction, the cups do not last very long with regular use.

Neither type feature a flat or semi flat area large enough for much walking (exercise.) Many don't allow more than one animal at a time because of their limited size. Also, both types of products are difficult to clean, which is a drawback because keeping a turtle or other animal requires very frequent cleaning of it's habitat.

In U.S. Pat. No. 5,121,709 issued to Lawrence Wechsler, a design is used which has legs and a much smaller flat surface and ramp due to it's shape. My unit differs greatly in that it has no legs (Wechsler's independent claims include a plurality of legs,) and my unit's body is solid or hollow, but either way it is enclosed, unlike Wechsler's. This keeps critters from going behind and under the unit and becoming stuck or otherwise uncomfortable. It also prevents the unit from moving as the legs or ramp in Wechsler's design may be hit or otherwise contacted by a critter, and thus, the unit may be moved. Also, the accessible area is much larger in my design because the width extends almost the entire width of the tank, and the flat platform is much wider because of its base design. Wechsler utilizes a natural looking tripod-like design, and my design utilizes a wedge-like design. My design allows creatures much more opportunities to move on the unit as there is more area for them to access, as well as allowing more creatures to use it at once, which is extremely important.

My unit overcomes the drawbacks of previous products, and I designed it because I myself need one.

### BRIEF SUMMARY

The unit is a molded or otherwise constructed piece/s of plastic or other material, with at least one sloped surface or ramp, with at least one area above the water line, and another (or more) area/s below the waterline.

The sloped surface/surfaces allow turtles or other animals easy access to the top or bottom. The unit is designed to fit closely with aquarium tanks or other containers so it doesn't move, therefore, it will not bang against its container.

The flat or semi-flat section is large enough for walking or other activities of multiple creatures, and large enough to allow use by multiple animals at the same time. Also, water-pet slope is rough enough to provide traction, yet smooth enough to clean easily with common cleaner (for example, dishwashing soap), and has fewer sections (as well as flatter sections) to clean than other products. The unit may be colored and/or textured to mimic the bank of a stream or river, which would give the habitat a natural look, both to the animals as well as the owners.

### BRIEF DESCRIPTION OF THE SEVERAL VIEWS OF THE DRAWING

Figure. I: Depicts the unit from above, and slightly to the side.

Figure IA: A flat or relatively flat section on the top, and a few other sections in front of it (going downwards towards the other side of the unit.) The back portion sits against the wall of the aquarium or other container.

Figure IB: Shows a slope and possible texture (stream bank colored.) A portion of the slope will be above, and a portion below, the surface of the water. The slope or slopes extend the width of the tank or container as to maximize surface area for the creature/s as well as prevent sideways movement. Also, more surface area gives the creatures more room to exercise.

Figure IC: The bottom and back of the unit are at a right angle as to fit the tank or container and prevent downward or backward movement. The sides may incorporate a painted design to give a natural look.

Figure ID: The front edge sits well in the tank or container so ease of use is allowed when getting on the unit. It also allows injured creatures (who can no longer swim but can still walk) a way to stay in the same tank or container as healthy creatures who still can swim as swimming onto the unit is not necessary to use it as the unit can be walked onto.

Figure. II: Depicts the unit in a standard aquarium tank.

Figure IIA: Standard aquarium tank.

Figure IIB: Broken line representing imaginary water line (note: the unit works at many water levels.)

Figure IIC: The unit in it's proper position in relation to the tank.

### DETAILED DESCRIPTION

This unit satisfies the needs of pet turtles or other animals by having the effect of dividing a rectangular (or other shaped) water tank or other container in two or more sections, allowing water turtles or other creatures to have an above water-line area and an under-the-water-line area. In a way, it may simulate the bank of a freshwater body. The unit's slope provides the turtles or other animals with ease of access to two or more divisions. The unit allows for ground locomotion as well as water locomotion, allowing the turtles or other animals multiple forms of exercise (sometimes, when trying to walk on the bare wet glass or other materialed floor of the tank or container, animals have trouble as there is no grip to provide traction.

Water-Pet Slope is a single unit (or comprising of multiple pieces to make a single unit) of molded or otherwise constructed plastic or other resin or material which gives a similar result (able to withstand long periods of time underwater without problems to its physical structure.) It's molded or otherwise constructed shape is slightly similar to that of a door wedge, with at least one portion of the top side being flat/level or semi-flat/semi-level, comprising a slope or multiple slopes. This dry section will be large enough to allow basking, walking, sleeping, etc. The entire unit (every portion) will support multiple creatures at a time.

This unit can be created with plastic resin and a mold. Other materials and processes to create the unit may be used, as long as the result functions the same.

This unit is designed to rest on the bottom of the tank or container (DOES NOT FLOAT.)

The unit will be semi-hollow or solid, depending on manufacturing or other costs involved. It will be enclosed, meaning creatures cannot go under or behind it. This prevents movement of the unit and keeps animals from becoming stuck or otherwise uncomfortable underneath it.

It's width is wide enough to sit flush or near flush with the sides of the tank or container, to prevent the unit from moving sideways. The back end of the unit also sits flush or near flush with the tank or container, so no backwards movement is possible. It's length is between ⅓ and ⅔ the length of the tank, and will be available in various sizes to fit in various sized tanks or other containers. Cornered designs may also be created eventually, and connectable designs may also be utilized.

The surface will not be molded smooth, but slightly rough/textured, to further allow grip for the turtles or other animals when they walk/climb. However, it will not be rough enough to cause injury to the creatures that use it. Also, it will be smooth enough to clean easily.

The color scheme and/or printed design used on the surfaces may incorporate colors found in the banks and beds of fresh water bodies in order to provide a natural look and feel to both the pets and the pet owners (it is designed to look both natural and pleasing to the eye.)

I claim:

1. An animal habitat or unit, designed to be used in various sized aquarium tanks or other containers, comprising;
a. a single piece or plurality of pieces designed to form a single molded, or otherwise formed unit, of plastic or other material, formed in such a way to prevent the unit from floating, with the base and body enclosed in such a way to prevent animals access under or behind the unit,
b. with one or more sloped surfaces or sections, and one or more of the sections of the unit designed to be above the water line of the tank or container, and one or more sections designed to slope below the waterline of the tank or container,
c. whereby turtles or other animals have access to a newly created above water area, and a below water area, giving the tank or container numerous sections.
